(19) United States
(12) Patent Application Publication
(10) Pub. No.: US 2005/0273712 A1
(43) Pub. Date: Dec. 8, 2005

(54) Method and system for transmitting texture information through communications networks

(76) Inventors: Jeffrey Allen Smith, Stouffville (CA); Ron Erickson, Toronto (CA); Dale Darling, Toronto (CA); Prasad Maruvada, Newmarket (CA)

Correspondence Address: Dallas F. Smith;Gowling Lafleur Henderson LLP, 2600-160 Elgin Street, Ottawa, ON, K1C 1P3, CA

(21) Appl. No.: 11/063,883

(22) Filed: Feb. 24, 2005

Related U.S. Application Data
(63) Continuation-in-part of application No. 09/262,056, filed on Mar. 4, 1999, now abandoned.

(51) Int. Cl. G06F 17/00

(52) U.S. Cl. 715/526; 345/581

(57) ABSTRACT

A system and method of rendering outputs from a predefined output definition such as an html file. The definition includes at least one texture expression that is evaluated to create a conventional texture picture or audio output to be employed in the rendering. The texture expression requires less storage space and/or transmission bandwidth than a conventional image or audio texture and yet can provide complex and/or intricate textures to increase visual and audio esthetics and interest in the resulting rendered output. Evaluation of texture expressions can be performed with absolute or relative screen coordinates, or other parameters such as elapsed time or current time, as variables for the expression.

### CROSS-REFERENCE OF RELATED APPLICATION

This application is a continuation-in-part of U.S. application Ser. No. 09/262,056, filed Mar. 4, 1999, which is incorporated herein by reference.

### FIELD OF THE INVENTION

The present invention relates to a method and system for transmitting texture information through communications networks. More specifically, the present invention relates to a method and system for creating, transmitting, storing and/or employing information defining image and/or audio textures in a bandwidth effective manner. Further, the present invention relates to a method and system for rendering said textures to visual and/or audio contexts.

### BACKGROUND OF THE INVENTION

Many computer applications employ textures to provide a pleasing and/or informative graphical display to users. For example, many web pages employ audio textures as background music or as audio effects such as button “clicks”, etc. The use of textures has been found to significantly increase the esthetics of web pages and assists in helping the viewer interact with and distinguish and absorb the information displayed on the page. Further, many graphical user interfaces for application programs employ image and audio textures to enhance the user's experience with the application program.

While the benefits of employing texture information on web pages and with various other applications are significant, there are disadvantages. One disadvantage, especially when textures are employed with applications requiring the texture information to be transmitted through a computer network, is that texture information can be relatively large and thus makes heavy use of network bandwidth. This can be especially problematic when multiple textures are employed for an application, such as a web page, as each texture can be many tens of kilobytes, or more, in size. Mobile technologies, such as cell phones, often have limited bandwidth and memory, and are therefore good candidates for efficient texturing methods and systems. Another disadvantage is that bitmap-based textures contain limited information, which limits the information available when attempting to render the image to larger or smaller dimensions. This often manifests as artifacts when rendering textures to smaller dimensions, or as blurriness or pixilation when rendering textures to larger dimensions, which is common when magnifying a texture or when rendering a texture to a high resolution display.

A variety of techniques have previously been employed to address this problem. For example, the creator of the web page or application interface, can select image textures that are relatively simple, and thus have a small size. However, this tends to limit the creativity of and choices available to the designer of the display. As another example, a small portion (e.g.—fifty by fifty pixels) of a more detailed texture can be employed and repeated (e.g.—tiled) over a large area of the display. However, tiling of textures still limits the creativity of the designer and can result in moire patterns or other undesired artifacts.

Similar problems exist with audio textures. As with image textures, the creator of the web page can select audio textures which are relatively small in size but which are repeated in a continuous loop to provide a desired duration. However, such repetition of audio textures can quickly become tedious and, in general, does not result in the desired heightening of interest in the web page or other application.

It is therefore desirous to have a system and method to transfer and/or render image and/or audio texture information which requires less bandwidth and/or storage space.

### SUMMARY OF THE INVENTION

It is an object of the present invention to provide a method and system to employ texture information which obviates or mitigates at least one disadvantage of the prior art.

According to a first aspect of the present invention, there is provided a method of rendering a user interface output from an output definition, comprising the steps of:

(i) retrieving an output definition to be employed to render a defined output;

(ii) parsing said output definition to identify one or more texture expressions;

(iii) evaluating each texture expression in terms of one or more texture expression evaluation parameters to obtain a texture output; and

(iv) rendering said defined output with each said texture output.(i) retrieving an output definition to be rendered;

According to another aspect of the present invention, there is provided a system to render an output from a predefined output definition including features to be rendered and at least one texture expression to be evaluated and employed in said rendering, comprising:

(i) a serializer for retrieving a predefined output definition from a local medium or from a communications network;

(ii) a parser in communication with the serializer for identifying from said output definition at least one texture expression and at least one texture expression evaluation parameter associated with the at least one texture expression;

(iii) an evaluator in communication with the parser for evaluating each said at least one texture expression in view of said at least one associated parameters to create a corresponding texture output for each said at least one texture expression; and

(iv) a renderer in communication with the evaluator for rendering said defined output with each said texture output

The present invention provides a novel method and system for creating, transmitting, storing, employing and rendering either or both image and audio textures. A texture expression is defined for a texture and is evaluated in view of one or more parameters, which can be the evaluation of prior texture expressions, to obtain the defined output. This output can then be combined, by a suitable renderer, with other information to be rendered to create user interface elements for an application, such as a program or web page. The texture expressions are quite small and can thus be stored and/or transmitted efficiently through communications networks, etc. Further, the algorithmic nature of the texture expressions provides single-pixel detail regardless of the render target resolution or the magnification factor applied to the rendered output.

### BRIEF DESCRIPTION OF THE DRAWINGS

Preferred embodiments of the present invention will now be described, by way of example only, with reference to the attached Figures, wherein:

FIG. 1 shows a representation of a Web browser application executing on a computer connected to the internet;

FIG. 2 shows the display of the Web browser of FIG. 1;

FIG. 3 shows a texture produced from a texture expression in accordance with the present invention;

FIG. 4 shows a texture produced from a modified form of the texture expression used for FIG. 3;

FIG. 5 shows another example of a texture produced from a texture expression in accordance with the present invention;

FIG. 6a shows a portion of the texture of FIG. 5;

FIG. 6b shows another portion, overlapping with that of FIG. 6a, of the texture of FIG. 5;

FIG. 7 shows a normalized definition for a textured polygon;

FIG. 8 shows a textured polygon produced with the definition of FIG. 7; and

FIG. 9 shows a schematic representation of one method of rendering an output with the present invention.

The file of this patent contains at least one drawing executed in color: Copies of this patent with color drawing(s) will be provided by the Patent and Trademark Office upon request and payment of the necessary fee.

### DETAILED DESCRIPTION OF THE INVENTION

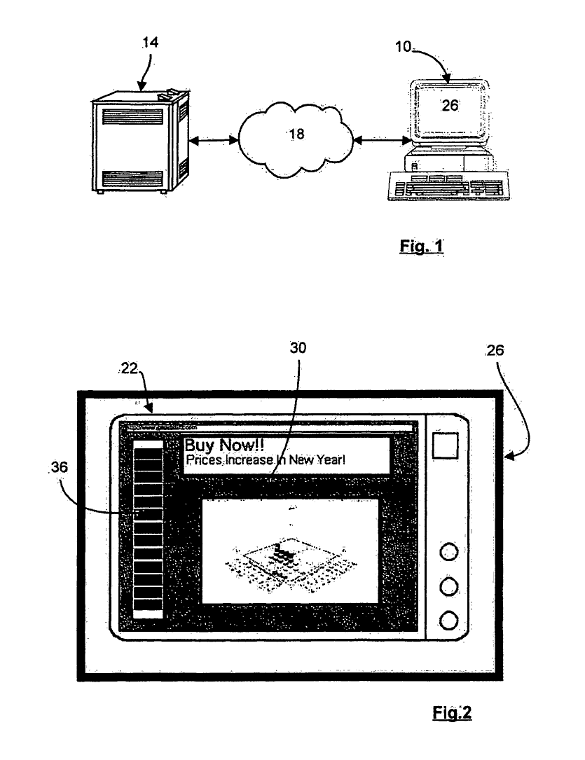

FIG. 1 shows a computer 10 which is connected to a server 14, such as an http server, through a communications network 18, such as the internet. FIG. 2 shows a typical output 22, such as a Web page or application program user interface, displayed on monitor 26 of computer 10. If audio is to be included in output 22, computer 10 can include an audio output device, such as a sound card and monitor 26 can include integral stereophonic speakers or separate speakers, not shown, can be employed. Output 22 includes a textured background 30 and textured buttons 36. In this specific example, the image texture employed for background 30 and the image texture employed for buttons 36 are each small portions of an image texture which are tiled to fill the desired space. Output 22 also includes several audio textures, including a background audio texture which is repeated continuously to provide “atmosphere” and audio textures to provide audible confirmation of selection of buttons 36 and/or other user interface events.

The source code for output 22 includes references to the image (in GIF, JPG or other suitable format) files containing the desired image textures and to the audio (in WAV or other suitable format) files containing the desired audio textures. These files are downloaded from server 14, via network 18, to computer 10 where output 22 is rendered with the downloaded files tiled and/or played as necessary.

As will be apparent, server 14 need not be connected to computer 10 via communications network 18 and can instead be part of computer 10. In this case, the source code for output 22 is stored on a storage device in computer 10 and is accessed as necessary. In such cases, the size of the textures within output 22 is somewhat less critical, but is still of some concern as there is a cost associated with acquiring sufficient storage space.

The present inventors have determined that texture information need not be transferred through network 18, or stored on a storage device, as picture or audio information. Instead, texture information can be stored or transmitted as a texture expression, which is a parametric form that can be processed at computer 10 to create the desired image or audio texture.

Specifically, the present inventors have determined that a texture can be defined by a texture expression which is a mathematical or other parametric expression, and computer 10 can access the texture expression, via network 18 or from a local storage device, and suitably process the texture expression to obtain the resultant audio or image texture as needed.

In a present embodiment, texture expressions can have more than one parameter and are defined such that the parameter values are normalized to a range of between 0 and 1. For example, an image texture expression can accept two parameters, such as X and Y position coordinates to obtain a 2D texture, or three parameters, such as X, Y and Z coordinates to provide a 3D solid texture or X, Y and t coordinates, where t represents time, to obtain an animated 2D texture. An audio texture expression can also accept one or more parameters, such as a time coordinate so that the texture varies with time, or X and Y position coordinates such that the texture varies with the position of a user interface event on a display (to provide a button click or other user interface feedback event), etc. The parameters can be mapped to the rendered display in a variety of manners, as discussed below. A texture expression can also have an implicit parameter defined therein. For example, an audio texture can have an oscillator function defined for it, such that a parameter oscillates between two values in a desired manner, such as a sinusoid. Such oscillator functions are discussed in more detail below.

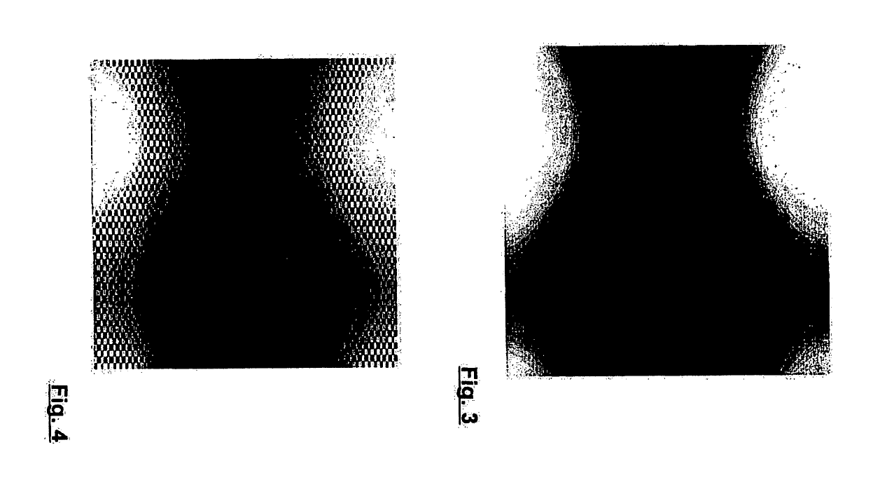

An example of an image texture expression is:
Merge(Sin(X( )), Cos(Y( )),0.8)

where the Merge( ) term combines three sub-terms to provide the Red, Green and Blue components of a resulting image, assuming an RGB colorspace, and a result produced by this expression is shown in FIG. 3.

In this example, for each pixel to be rendered on a display the Red plane is taken to be the Sin of the X coordinate value of the pixel and, in a present embodiment of the invention, the Sin function is operable to provide a complete Sin wave over the range 0 to 1. As can be seen in FIG. 3, the red component increases from left to right as the X value increases (assuming a cartesian coordinate system wherein 0,0 is at the upper left comer of the image and 1,1 is at the bottom right comer of the image). The values of Sin(X) that would normally be less than zero are clamped to zero, so the red component of the image is effectively zero on the right hand side of the image.

Similarly, the Green plane of the image is defined by the Cosine of the Y coordinate and, in a present embodiment of the invention, the Cos( ) function is operable to provide a complete Cosine wave over the range 0 to 1. As is apparent from the Figure, the green component of the pixels is at “full on” (1.0) at the top of the image, corresponding to the value of Cos(O.O), and the values drop down below zero, and are clamped to zero, in the middle range of the image and then peak back up to 1.0. at the bottom of the image.

Finally, the Blue plane of the image is defined by a constant value of 0.8. Hence the pixels with strong green values and no red value (upper right corner) show as aqua (the blending of green and blue), regions with strong red and blue, but no green (middle left) show as magenta and regions with full red and green, and strong blue show as bright, pale yellow.

As will be apparent to those of skill in the art, the present invention is not limited to the Merge( ), Cos( ) or Sin( ) functions and other functions and expressions can be employed. Also, the present invention is not limited to the Cos( ) and Sin( ) functions operating as described above, and other operations of these functions, such as the outputting of negative values (rather than clamped positive values) can be employed if desired.

The particular example of FIG. 3 is not strongly textured. But, by simply replacing the blue channel with a more complex term, images more closely resembling a conventional texture can be generated with almost no impact on the size of the definition string. In particular, FIG. 4 shows the result produced by amending the expression to
Merge(Sin(X( ), Cos(Y( )),Checker(0.02,0.01))

In this example, the only difference is that the constant blue value of 0.8 has been replaced by a Checker( ) function that generates a checkerboard pattern with tiles of size 0.02 by 0.01. Other textural effects can be achieved by replacing the Checker( ) function term with other effects, such as noise or fractal patterns.

In addition to a color value, image texture expressions can also produce a transparency value, typically referred to as an alpha channel value for each pixel. The combination of a color value and an alpha channel value allows the resulting texture to be composited with other image information or texture images.

As will now be apparent, complex, intricate, textures can result from evaluation of such texture expressions, despite the fact that the expression itself can be represented in a few tens of bytes which allows for efficient storage and/or transmission of the texture.

A variety of techniques can be employed in mapping the display to the texture expression and this too can vary the result obtained from a texture expression. In one embodiment, the parameters in the texture expression are mapped in an absolute manner to the pixels in output 22. More specifically, each pixel in output 22 can be represented with an x-position (across the display) and a y-position (down the display) and these coordinate parameters are mapped such that the increase in the value of a coordinate between adjacent pixels is a constant, i.e. a pixel at (0, 0) is mapped to (0, 0); a pixel at (1, 0) is mapped to (0.0015625, 0); a pixel at (5, 0) is mapped to (0.0078125, 0), etc., irrespective of the resolution of the display device and/or the size of the area to which the texture is to be applied.

Thus, with an absolute mapping, if two regions of different size and/or position employ a texture expression given above, the common area of the two areas will have a common portion of the texture and any non-common areas will have a different portion of the texture. FIG. 5 shows another texture which has been produced with the present invention, from the expression
ColorGrad(Abs(Merge(Cos(x( ), Sin(y( )),0.74)),x( ),Exponent(Abs(Times(x( ),y( ))))).

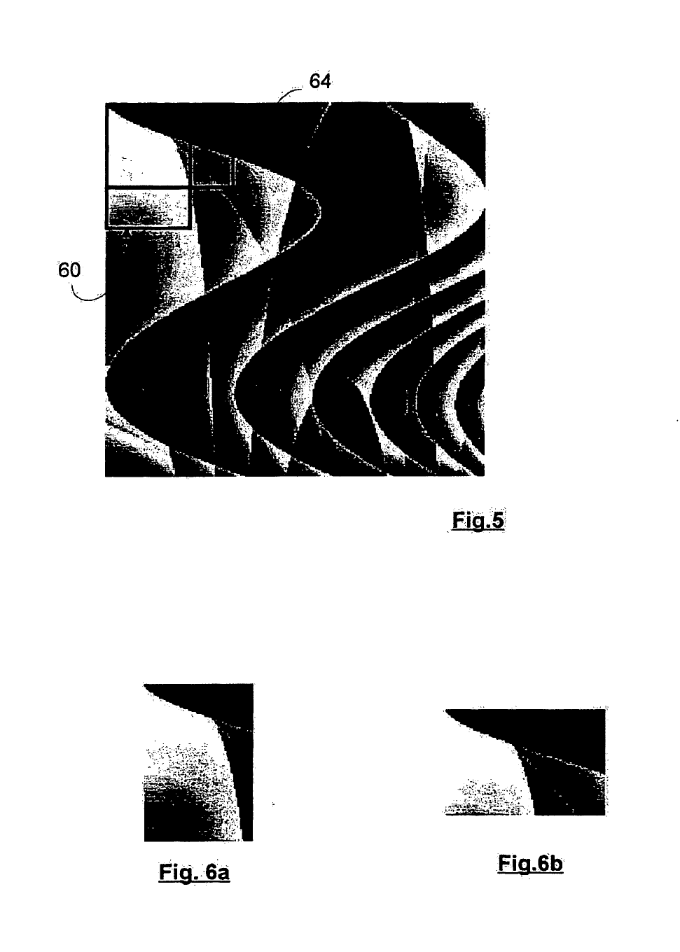

FIG. 6a shows the texture produced for a rectangular area extending from (0, 0) to (99, 149), indicated by area 60 in FIG. 5, with the texture expression given above, while FIG. 6b shows the texture produced for a rectangular area extending from (0,0) to (149, 99), indicated by area 64 in FIG. 5, with the texture expression given above.

With such an absolute coordinate system, buttons 36 in output 22 will have differing resulting portions of the textures applied to them, even though the texture expression applied to them is the same for each button 36. Specifically, the upper most button can have pixels with x values ranging from 50 to 100 and y values ranging from 200 to 250 and the button immediately below it can pixels with the same x value range but a y value range of 275 to 325. Thus with an absolute mapping, evaluating the same texture expression for each button will yield different texture results.

It is also possible for the mapping to be performed on a relative basis. Specifically, in such a case the mapping operates such that the maximum extents of the area to which the texture is to be applied are mapped to the value 1 and the minimum extents being mapped to 0 and the intermediate values being mapped proportionally. For example, if a texture expression is to be applied to a rectangular area of fifty by fifty pixels (i.e. x and y values each extend between 0 and 49) a pixel at (24, 24) will be mapped to (0.5, 0.5). If the same texture expression is to be applied to a rectangular area of two hundred by two hundred pixels (i.e. x and y values extend from 0 to 199), a pixel at (24, 24) will be mapped to (0.12, 0.12). Thus, the upper left comer of each button 36 can be defined as position (0, 0) and the mapping and evaluation of the texture expression will yield the same results for each button, although a larger button may have finer detail present in the texture due to the increased number of rendered, and evaluated, pixels therein.

Independent of the mapping, it is also possible to define the texture expression in a recursive manner such that the value of a pixel depends upon one or more proceeding (previously determined) pixel values as well as the present pixel location. In such a case, a texture will vary depending upon the shape and size of the area to which the texture is applied.

In either mapping system and with recursive or non-recursive expressions, the result of the evaluation of the texture expression can either be a single value representing the color to be displayed at the corresponding pixel or can be a value representing one color component in a color space, such as RGB (red, blue and green), hsv (hue, saturation and value), etc. to be used to form the color to be displayed at the pixel. In these latter cases, each pixel can have three different values determined for it and three texture expressions can thus be evaluated for each pixel. These three texture expressions can be similar or quite different, allowing a designer a great deal a flexibility to employ quite complex and visually intricate textures if desired. Similarly, as also mentioned above, the texture expression can also provide an alpha channel value for the final color value to be displayed at a pixel. Alternatively, an alpha channel value can be determined for each color component in the final color value. Further, in addition to supporting arbitrary color spaces, texture expressions can also generate channel values, other than alpha, to provide information relating to z-depth or other arbitrary value domains that convey information about the region represented by the pixel.

It is also contemplated that texture expressions can be evaluated with a mixture of mapping systems and that recursive or non-recursive texture expressions can be mixed. For example, the red and green values for a pixel can be determined by evaluating two different non-recursive texture expressions with an absolute mapping system, while the blue value is determined by evaluating another texture expression, either recursive or non-recursive, with a relative mapping system. If the texture expressions for the red and green values have visually dominant features, this can allow the designer to achieve a specific visual look for the overall output 22 and still differentiate specific regions of the display with the different texture expression for the blue value which can be selected to be less visually dominant or vice versa.

It will be apparent to those of skill in the art that tiling of textures produced from texture expressions may be desired in some circumstances. In such cases, a texture expression can be evaluated for example, on a relative mapping basis, for adjacent areas of a preselected size. It is also contemplated that mirror-imaged mapping can be performed by evaluating the texture expression in adjacent preselected areas with inverted mappings in either the x or y or both directions. Such mirror-imaged mapping can provide a smoother transition at edges of the areas for some textures.

Another alternative which is presently preferred, is to set a predefined oscillation function to provide parametric values for use in evaluation of the texture expression. For example, a value to be employed as the x value for an expression may be set to “oscillate” smoothly from 0.0 to 1.0 and back to 0.0. In this alternative, the oscillation function can be selected to produce values with the characteristics of a sinusoid, saw tooth, triangle or other waveform to control the visual appearance of the reflections. For example, if a function is selected with sinusoidal characteristics, a visually smooth reflection is obtained while, if a function is selected with saw tooth characteristics, the resulting reflections appears visually harsh and abrupt. Oscillation functions can also include an orientation parameter such that x, y and/or other axis values can be derived, allowing mirroring about rotating, non-orthogonal or axis.

A simple example of an oscillator function is SineWave(f), which produces a sine curve with frequency f (in radians) over the range 0 to 1. Thus, for example, the texture expression for FIG. 3 can be modified to include an oscillator function to obtain
Merge(Sin Wave(0.3), Cos(Y( ),0.8)

where the red component of the pixel color varies smoothly and sinusoidally between 0 and 1. Oscillator functions are not limited to functions which provide smoothly changing values and discontinuous and/or non-linear functions can be employed as desired.

In addition to screen coordinates or oscillation functions, another parameter which can be employed with texture expressions is time. Like the other parameters discussed above, in a presently preferred embodiment of the invention the time coordinate is normalized to a range of 0.0 to 1.0 and can be mapped to the end application in a variety of manners. For example, a time of t=0 can be defined as the time at which the evaluation of the expression is first commenced and a fixed increment and time for each subsequent evaluation can be defined. For example, for animated textures the time for each evaluation can be defined such that the texture is updated for each displayed frame (e.g.—every a one thirtieth of a second for a thirty frame per second system). In such a case, the increment size is defined such that a desired duration of the animation is produced. A time parameter can also be mapped to an elapsed time, such as the time since a user interface event (mouse click, etc.) has occurred, the speed with which a mouse movement is occurring, a real time clock or any of a number of other mappings. As will be apparent to those of skill in the art, in real time situations, such as games, etc., frames can be dropped and/or other performance bottlenecks accommodated without the texture getting out of synchronization with timing of a sequence as the texture expression need only be evaluated with the appropriate time to obtain the desired result.

Other, non-screen coordinate, parameters can be employed. For example, a page( ) function can be employed to modify the result of a texture expression to change its result depending upon the present page number of a document displayed. It is contemplated that those defining texture expressions can define functions, such as the page( ) function, as desired.

Tiling of the time parameter can also be performed and this is one manner by which an animated texture can be obtained from a texture expression. For example, once the time parameter reaches the maximum value of one, at the end of a desired duration, the value can be “wrapped” to zero (effectively tiling the texture), or the sign of the increment can be reversed, such that time decreases toward zero and, upon reaching zero, reversed again (effectively mirror-image tiling the texture) as desired. As will be apparent, this results in a function, much like the oscillator function described above, wherein parameters can be implicitly defined with the texture expression. In fact, a variety of oscillator functions can be employed, including non-linear and discontinuous functions, if desired.

The use of such time oscillators can produce some very interesting effects, particularly with respect to controlling the speed, acceleration and repetition of an animated texture.

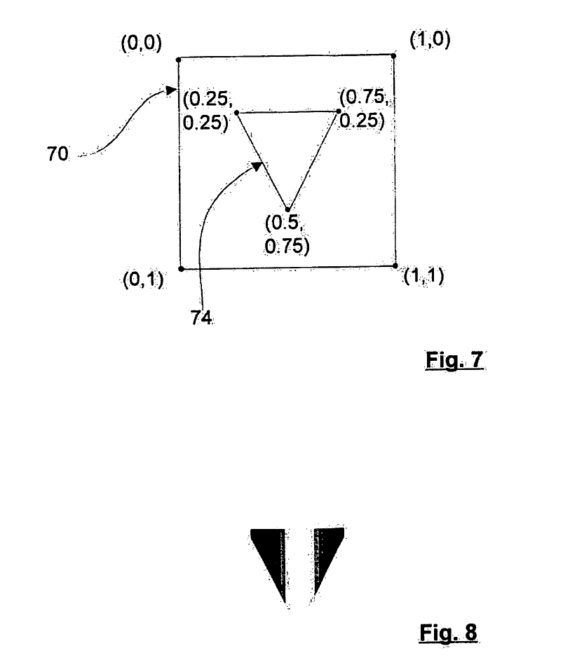

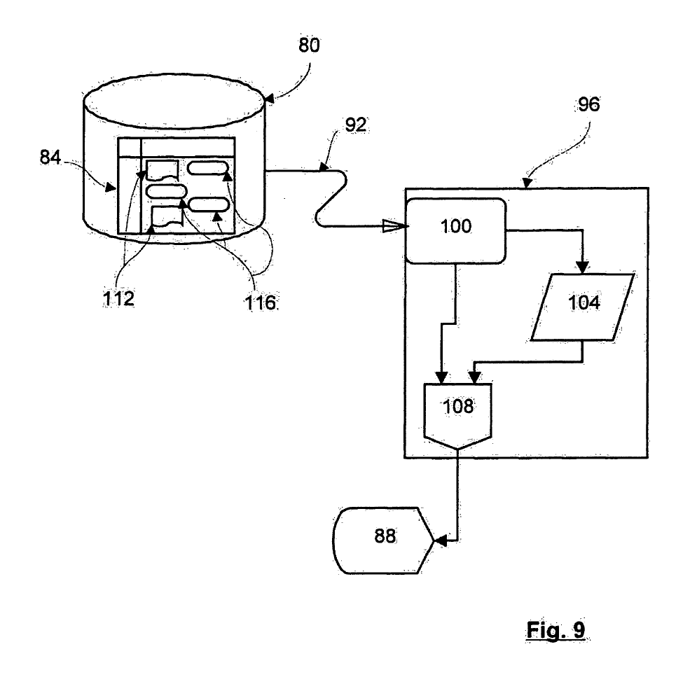

In yet another embodiment of the present invention, texture expressions can be employed to create textured polygons. As used herein, the term polygon is intended to comprise any area defined by three or more control points and can include areas that are enclosed by straight lines extending between control points and/or any area defined by two or more control points enclosed by splines extending between control points. Such polygon texture expressions include, in addition to the definition of the color to be displayed, a definition of the control points or vertices of a polygon within the normalized rectangle with coordinates of (0, 0) to (1,1) or whatever other defined coordinate space is employed with the present invention. The polygon texture expression can include a function to set the alpha channel to zero (transparent) for all pixels outside the boundaries of the polygon to obtain a textured polygon with the desired shape. FIG. 7 shows a rectangular texture definition 70 which includes three vertices (at (0.25, 0.25); (0.75, 0.25); and (0.5, 0.75)) that defined a polygon 74. FIG. 8 shows a textured polygon which can result from the evaluation of a texture expression which includes a function to set the alpha channel for all points outside of polygon 74 to zero. For points within polygon 74, the alpha channel can be fixed at one, or can be varied, as desired, by the evaluation of the remainder of the texture expression.

As discussed above, the texture expressions of the present invention can also be defined to produce audio textures. Such audio texture expressions operate in much the same manner as image texture expressions and can be evaluated in view of one or more parameters, including 2D or 3D screen coordinates, or more preferably, time or other parameters such as the above-described oscillator functions as will occur to those of skill in the art. As with the image textures discussed above, it is presently preferred that these parameters be normalized to a range of 0 to 1 and be mapped to an non-normalized parameter space as desired. For example, screen coordinates can be mapped to the normalized 0 to 1 space with relative or absolute mappings, or time related parameters can be mapped as discussed above. In many circumstances, an audio texture expression will produce an audio waveform, or waveforms, to be output for a determined duration. However, as was the case with alpha channel values with image texture expressions, one or more additional values such as a reverb or echo value, dependent upon a screen coordinate for example, can also be produced within the texture expression to modify the output of the texture expression. Also, much like alpha channel values, mixing values can be produced and employed to composite audio textures together as desired. The resulting waveforms can thus be polyphonic and multi-timbral.

In the present invention, a texture expression can be stored in a structure referred to by the present inventors as a “textile” which includes at least one texture expression. More usefully, a textile can include multiple texture expressions for textured polygons and/or textures which are composited together as desired when the textile is evaluated. If a textile includes more than one texture expression or textured polygon, the textile also includes a compositing stack which defines the order and blending technique by which the textures are to be composited.

FIG. 9 shows a block diagram of one use of the present invention. As shown, a server 80 which can either be located remote from or within a computer system, includes a definition 84 of an output to be created on an output device 88, such as a computer monitor and FM synthesizer with stereophonic sound output. Definition 84 is provided via a communications system 92, which can be an internal bus in the computer system or a telecommunications network such as the internet, to a display generation engine 96, such as an http browser or the user interface of an application program. Display generation engine 96 includes a definition parser 100, similar to a conventional html parser, a texture expression evaluator 104 and an output renderer 108.

Definition 84 can comprise a number of components, including one or more text objects 112 and one or more texture expressions 116 which can be image or audio textures, textured polygons or textiles. As definition 84 is received at definition parser 100, any received texture expressions 116 and related information such as coordinate system mappings, texture positions, start times, etc. are passed by parser 100 to texture expression evaluator 104 and the remainder of definition 84 is passed to output renderer 108. Texture expression evaluator 104 processes each texture expression in turn to produce the corresponding textures that are then supplied to output renderer 108 as conventional image textures and/or sounds. Output renderer 108 then renders the finished display, including the texture images and sounds defined by the texture expressions, either for immediate display on output device 88, or to be stored for subsequent display.

As will be apparent to those of skill in the art, in many circumstances designers of an output will select and/or mix and match desired texture expressions from a library of supplied texture expressions. However, in one embodiment of the present invention designers are provided with a toolkit allowing them to create new image or audio texture expressions as desired.

It is contemplated that a variety of techniques can be employed to create texture expressions, either to create the above-mentioned library or to provide to designers with a toolkit to create desired new textures. The present inventors currently employ a genetic algorithm system to create texture expressions. The use of genetic algorithms to produce graphic information is known and is described, for example, in the article, “Artificial Evolution for Computer Graphics”, by Karl Sims, published in Computer Graphics, Volume 25, Number 4, July 1991, the contents of which are incorporated herein by reference. This reference teaches a system of creating procedural definitions for graphics information via genetic algorithms. Another discussion of such systems is given in the chapter called “Genetic Textures”, in the book “Texturing and Modeling: A Procedural Approach”, second edition, David S. Ebert, F. Kenton Musgrave, Darwyn Peachey, Ken Perlin and Steven Worley, Copyright 1998,1994 by Academic Press ISBN 0-12-228730-4 and the contents of this reference are incorporated herein by reference.

In the genetic algorithm system of the present invention, a texture can be created by the designer randomly varying starting conditions and setting various parameters or by “breeding two or more existing texture expressions and observing and selecting interesting results. Alternatively, a designer can attempt to create a specific desired texture. It is contemplated that in many circumstances a designer will already have available a texture, in the form of a conventional texture picture or audio sample, which the designer wishes to closely mimic with a texture expression to reduce storage and/or transmission bandwidth requirements. In such a case, the generations of texture expressions produced by the genetic algorithm process will be judged for success by comparison to the conventional texture picture or audio sample, either by the designer or by a program tool that can measure “fit”. Selecting generations of survivors based upon their closeness to the desired conventional texture can yield texture expressions which mimic or resemble the conventional texture, yet which require much less storage space and/or transmission bandwidth.

The above-described embodiments of the invention are intended to be examples of the present invention and alterations and modifications may be effected thereto, by those of skill in the art, without departing from the scope of the invention which is defined solely by the claims appended hereto.

1. A method of rendering a defined output from an output definition, comprising the steps of:
retrieving an output definition to be employed to render a defined output;
parsing said output definition to identify one or more texture expressions;
evaluating each texture expression in terms of one or more texture expression evaluation parameters to obtain a texture output; and
rendering said defined output with each said texture output.

2. A method as claimed in claim 1, wherein said output definition is retrieved from though a communications network.

3. A method as claimed in claim 1, wherein said output definition is retrieved from a local medium.

4. A method as claimed in claim 1, wherein said output definition is a markup language document, such as XML or similar.

5. A method as claimed in claim 1, wherein at least one of said texture expressions produces an image texture.

6. A method as claimed in claim 1, wherein at least one of said texture expressions produces an audio texture.

7. A method as claimed in claim 1, wherein at least one of said texture expressions is a mathematical function.

8. A method as claimed in claim 1, wherein at least one of said texture expressions is an oscillation function.

9. A method as claimed in claim 1, wherein at least one of said texture expressions is a bitmap image.

10. A method as claimed in claim 1, wherein at least one of said texture expressions is a vector definition.

11. A method as claimed in claim 1, wherein said texture expression evaluation parameters include a constant parameter.

12. A method as claimed in claim 1, wherein said texture expression evaluation parameters include coordinates expressed in zero-to-one space.

13. A method as claimed in claim 1, wherein said texture expression evaluation parameters include a time-based parameter.

14. A method as claimed in claim 13, wherein said time-based parameter comprises an elapsed time from a user interface event.

15. A method as claimed in claim 1, wherein said texture expression evaluation parameters include at least one of said texture outputs, providing recursive or hierarchical structuring of said output definition.

16. A method as claimed in claim 5, wherein said texture expression's parameters include one parameter for each color value of a multi-value color space.

17. A method as claimed in claim 16, wherein said multi-value color space is RGB (Red/Green/Blue) color space.

18. A method as claimed in claim 16, wherein said multi-value color space is RGBA (Red/Green/Blue/Alpha) color space.

19. A method as claimed in claim 16, wherein said multi-value color space is CMYK (Cyan/Magenta/Yellow/Black) color space.

20. A system to render a defined output from an output definition, comprising:
a serializer for retrieving a predefined output definition from a local medium or from a communications network;
a parser in communication with the serializer for identifying from said output definition at least one texture expression and at least one texture expression evaluation parameter associated with the at least one texture expression;
an evaluator in communication with the parser for evaluating each said at least one texture expression in view of said at least one associated parameters to create a corresponding texture output for each said at least one texture expression; and
a renderer in communication with the evaluator for rendering said defined output with each said texture output

21. A system as claimed in claim 20 wherein said texture output is a texture image and said texture expression evaluation parameters include a polygonal definition of an area within said texture output for which said corresponding texture image is to be applied.

22. A system as claimed in claim 20 wherein said texture output is an audio texture and said texture expression evaluation parameters include a time-based parameter.
